(19) United States
(12) Patent Application Publication
(10) Pub. No.: US 2005/0109375 A1
(43) Pub. Date: May 26, 2005

(54) Vent cleaning system

(76) Inventor: Scott Peterson, Ft. Worth, TX (US)

Correspondence Address: Keith D. Nowak;DICKSTEIN SHAPIRO MORIN & OSHINSKY LLP, 41st Floor, 1177 Avenue of the Americas, New York, NY, 10036-2714, US

(21) Appl. No.: 10/721,859

(22) Filed: Nov. 26, 2003

(51) Int. Cl. B08B 7/00

(52) U.S. Cl. 134/22.1; 134/6; 134/21

(57) ABSTRACT

An improved vent cleaning apparatus for removing dust from air conditioning and heating vents and wherein unnecessary toque loads on the flexible shaft are eliminated by the presence of swivel cuff means between the exhaust opening where the flexible tubular conduit containing the shaft is connected to the apparatus and the flexible tubular conduit itself.

### FIELD OF THE INVENTION

This invention relates generally to an improved vent and duct cleaning system, and specifically to an improved vent cleaning system for removing dust from air conditioning and heating vents and ducts of residential and commercial buildings.

### DESCRIPTION OF THE PRIOR ART

House dust is widely considered by experts to pose serious health hazards to persons with allergies, asthma or respiratory disorders and diseases, since it is known to contain dirt, textiles fibers, pollen, hair, skin flakes, residue of chemical and household products, decaying organic matter, dust mites, bacteria, fungus, viruses and a variety of other contaminants. Pounds of house dust accumulate in vents and ducts that comprise the ventilation systems of residential and commercial buildings. This house dust is becoming increasingly more harmful as Americans spend a larger percentage of their waking hours indoors.

Air filters are often placed at the intake of ventilating systems. However, such filters are often inadequate in removing the majority of the dust from the air. Filters may trap as little as twenty percent of the house dust circulating in a ventilation system, allowing the remaining dust to circulate in the household or work place.

Outbreaks of diseases have been linked to improperly maintained ventilating systems, including the outbreak of Legionnaire's disease in 1976.

A vent cleansing system has been described in U.S. Pat. No. 4,792,363, which was issued Dec. 20, 1988 to S. P. Franklin, Jr., et al, and is comprised of a brush that substantially occludes the vent and is rotated by a flexible shaft that is concentrically disposed in a flexible tubular vacuum conduit, so that dust dislodged from the vent wall is vacuumed into the conduit.

Although the system of the patent has met with commercial success as evidenced by its wide use in the cleaning of commercial and residential heating and ventilating systems, an important drawback is that at times the combination of a spinning cable and a fixed conduit imparted unnecessary, unwanted and potentially damaging torque loads on the flexible shaft. It was concluded that this torque load has contributed to an increase in flexible cable failures. The previous fixed cuff of the system described in the '363 patent did not allow any rotation of the flexible tubular vacuum conduit, which had a negative impact on cable performance.

Accordingly, one or more of the following objects will be achieved by the practice of the present invention. It is an object of this invention to provide an improved vent cleansing system for removing dust from air conditioning and heating units and ducts of residential and commercial buildings. Another object of this invention is to provide an improved vent cleaning system which eliminates unnecessary toque loads on the flexible shaft. A further object of this invention is to provide an improved system, wherein there is no negative impact on cable performance.

A still further object is to provide an improved vent cleaning system wherein the flexible tubular vacuum conduit contains rotation means whereby problems of toque loads on the flexible shaft are markedly reduced or eliminated entirely. These and other objects will readily become apparent to those skilled in the art in light of the disclosure contained herein.

### SUMMARY OF THE INVENTION

The present invention is an improved system for removing dust from a vent, or plurality of vents that comprise a ventilation system. In the preferred embodiment, the apparatus comprises the combination of a flexible tubular conduit having an intake opening at one end and an exhaust opening at the opposite end, a flexible rotatable shaft concentrically disposed within said flexible tubular conduit and substantially extending between said intake opening and said exhaust opening, a soft bristled brush coupled to said flexible rotatable shaft at the intake opening of said flexible tubular conduit, a shaft motor means for rotating said flexible rotatable shaft, a vacuum means for entraining dust dislodged by the action of the brush, and a swivel cuff disposed between said vacuum means and the exhaust end of said flexible tubular conduit.

As a method, the present invention comprises a combination of inserting a brush that is coupled to a flexible rotatable shaft disposed within a flexible vacuum conduit into a vent, rotating the flexible rotatable shaft to cause the brush to rotate in the vent and dislodge dust, and applying a vacuum source to the vacuum conduit to draw an air stream containing the dust from the vent into the conduit. The presence of the swivel cuff minimizes potentially damaging toque loads of the flexible shaft and thereby extends the life of the flexible cable itself.

### BRIEF DESCRIPTION OF THE DRAWINGS

FIG. 1 is a perspective view of this improved apparatus in accordance with the present invention, showing in partial cut-away view a brush reasonably disposed in a vent shown in cross-section;

FIG. 2 is a is a perspective view showing the swivel cuff;

FIG. 3 is a cross-sectional view of the sanitary T of FIG. 1 showing the swivel cuffof FIG. 2;

FIG. 4 is a cross-section view of the brush assembly of FIG. 1.

### DETAILED DESCRIPTION OF THE INVENTION

It has been observed that the improved vent cleaning system of the present invention provides several advantages over previous systems, not only in the reduction of cable failures, but in several other aspects. It has been noted on several occasions that when the cable spins inside of the flexible conduit, the flexible conduit at times disconnects from the unit. The swivel cuff eliminates this problem. When wrapping the flexible tubular conduit (the hose) around the vacuum and filter unit, a fixed cuff sometimes made this procedure difficult and time-consuming. The new swivel cuff eliminates this problem. In the past with the fixed cuff, some operators have improperly attempted to remove the conduit from the machine by twisting the conduit some distance away from the cuff. This has caused the cuff to be forcibly separated from the conduit, requiring repair. With the swivel cuff, an operator wishing to remove the flexible conduit is now required to firmly grasp the cuff at the machine to disconnect it, thus eliminating this problem.

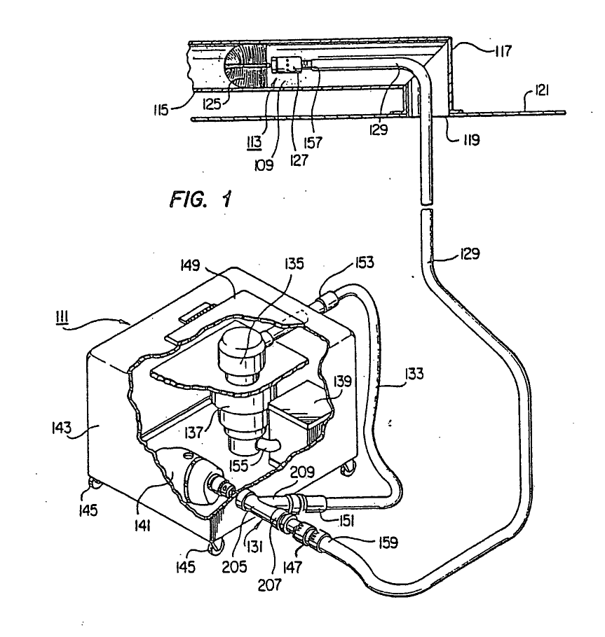

In FIG. 1, the vent cleaning apparatus 111 is shown in partial cut-away view. Brush assembly 113 of vent cleaning apparatus 111 is shown disposed in vent 115. Vent 115 is shown in cross-section. For purposes of this application, the term “vent” is considered to comprehend all types of ventilating system conduits, including vents and ducts.

Vent 115 runs parallel to ceiling 121, then forms a right angle 117 with the ceiling 121, and terminates at vent opening 119. This is a very common configuration for vents.

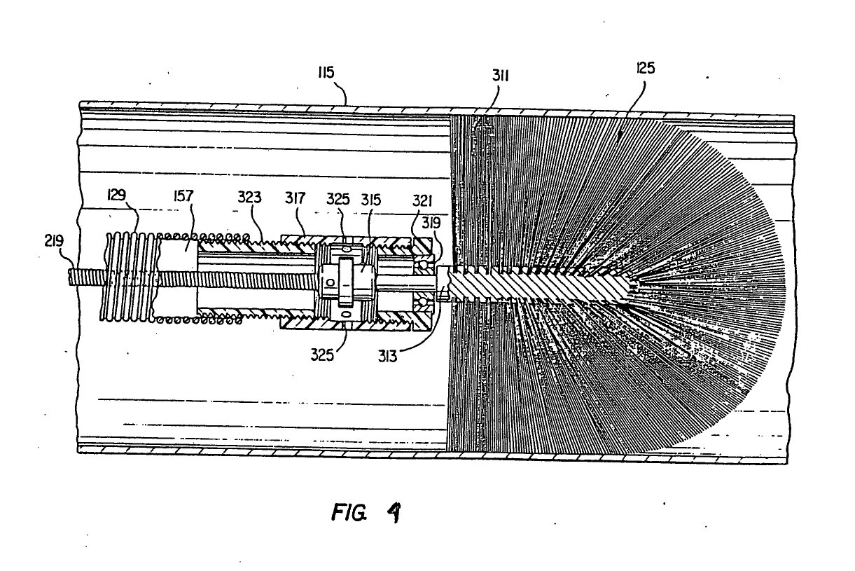

Brush assembly 113 comprises brush 125, collar 127, and flexible tubular conduit 129. In the preferred embodiment, flexible tubular conduit 129 is approximately a 30 feet long, 1^{1/2} or 2 inch diameter flexible plastic hose, having an intake opening 157 (not shown) in close physical proximity to brush 125, and an exhaust opening 159 (not shown) at the opposite end. Collar 127 is carried in intake opening 157, and is adapted to rotatably carry brush shaft 313 of FIG. 4.

In the preferred embodiment, swivel cuff 147 is secured to the exhaust opening 159 of flexible tubular conduit 129 and serves to releasably mate the flexible tubular conduit 129 with leg 207 of sanitary-tee 131. Sanitary-tee 131 is preferably a y-shaped (shown in FIG. 3) or t-shaped connector formed of 1^{1/2} or 2 inch diameter polyvinylchloride tubing, having a head 205, and two legs 207, 209.

Head 205 of sanitary-tee 131 mates with housing 143 of vent cleaning apparatus 111. Housing 143 preferably is a rectangular fiberglass housing, having a hinged door 149 disposed along its top region allowing access to the interior of said housing 143. Housing 143 is preferably supported by either four casters 145 or two casters and two wheels, thus allowing the vent cleaning apparatus 111 to be moved with ease.

A shaft motor is disposed rearward of the sanitary-tee 131, in the interior of housing 143. In the preferred embodiment, shaft motor 141 comprises a ¼ horsepower electric induction motor which is releasably coupled to a flexible shaft 219 shown in FIG. 3. Shaft motor 141 can be any type of motor so long as it provides a rotational force to flexible shaft 219.

A vacuum hose 133 is connected to leg 209 of sanitary-tee 131 by female vacuum hose connector 151. In the preferred embodiment, vacuum hose 133 is a ten foot long 1^{1/2} inch diameter flexible hose. The opposite end of vacuum hose 133 mates with vacuum intake 153 which is disposed along one side of housing 143. It is to be understood that vacuum hose 133 could be replaced with PVC piping internal to vent cleaning apparatus 111.

Vacuum intake 153 leads to the interior of housing 143; specifically to filter 135 which is disposed above and coupled to a vacuum motor 137. In a preferred embodiment, the vacuum motor 137 is an Amtek 1^{1/4} horse power electric motor, of the type commonly found in vacuum cleaning equipment. Bag feed conduit 155 leads from vacuum motor 137 to vacuum bag 139. Although one vacuum motor is shown and described, two or more vacuum motors can be used in the present vent cleaning system.

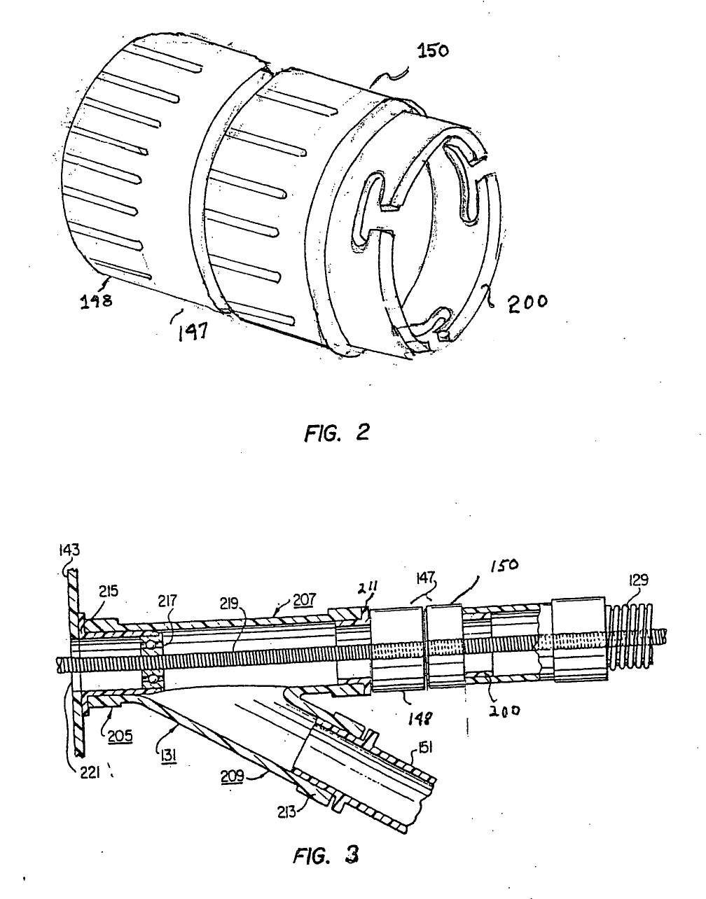

FIG. 2 is a perspective view of swivel cuff 147, which is comprised of base 148, which is threadley engaged to leg 207 of sanitary-tee 131, through female threaded base 148 (not shown) which screws onto a comparable threaded male member affixed to leg 208 (not shown). Collar 150 is attached to base 148, but can freely revolve around base 148 and also contains section 200 for coupling and uncoupling to the exhaust flexible tubular conduit 129. The swivel cuff can be made of plastic, such as polyvinyl chloride.

FIG. 3 is a cross-section view of sanitary-tee swivel cuff 147 of FIG. 1. As in FIG. 1, the sanitary-tee 131 is disposed and swivel cuff 147 between housing wall 143 and flexible tubular conduit 129. Male connector 211 is disposed in the opening of leg 207, and is adapted to mate with base 148 of swivel cuff 147.

Female connector 213 is formed in the opening of leg 209 of sanitary-tee 131, and is adapted to mate with vacuum hose 133 at male vacuum hose connector 151.

The head 205 of sanitary-tee 131 is adapted to mate with male housing connector 215. Bearing 217 is carried by male housing connector 215. Bearing 217 includes a bore having a diameter sufficient for receiving the flexible shaft 219. In the preferred embodiment, bearing 217 is a 1^{1/2} inch diameter bearing having at least a 3/8 inch diameter bore for receiving a 3/8 inch diameter flexible shaft of the type used by plumbers, and referred to in that trade as a “snake.”

Flexible shaft 219 is releasably coupled to flexible shaft motor 141 and exits housing 143 at shaft opening 221. Flexible shaft 219 enters head 205 of sanitary-tee 131, passes through bearing 217, extends along leg 207 of sanitary-tee through the swivel cuff 147, and enters flexible tubular conduit 129, where is it substantially concentrically disposed. In the preferred embodiment, flexible shaft 219 is a 30 foot flexible shaft that extends the entire length of flexible tubular conduit 129 to the collar 127 of brush assembly 113 in FIG. 1.

Flexible shaft has a diameter substantially smaller than the diameter of the flexible tubular conduit 129. Flexible shaft 219 also serves to provide some rigidity to tubular conduit 129.

FIG. 4 is a cross-section of brush assembly 113 disposed in vent 115. Brush 125 has a plurality of flexible bristles 311 carried on a brush shaft 313. Brush 125 is adapted in size to substantially occlude vent 115. Brush shaft 313 is coupled to a flexible shaft 219 by coupling 315 which is disposed in collar 317, which in the preferred embodiment is a 1^{1/2} or 2 inch diameter polyvinylchloride pipe collar.

Brush shaft 313 is carried in collar 317 by bearing 319, which in the preferred embodiment is 1^{1/2} inch diameter bearing having a 3/8 inch hole for receiving brush shaft 313. Bearing 319 is carried in a bearing assembly 321, which is adapted to threadingly engage with collar 317. A threaded conduit connector 323 fits in intake opening 157 of flexible tubular conduit 129, and is adapted to threadingly engage collar 317. A plurality of intake ports 325 are provided in collar 317. These intake ports 325 allow air to flow between the interior space of vent 115 and the intake opening of flexible tubular conduit 129.

In addition, a nozzle unit such as that described in U.S. Pat. No. 6,279,197, the contents of which are incorporated herein by reference, can also be used in the present vent cleaning system.

In operation, the vent cleaning apparatus 111 is used to remove dust 109 from vent 115. The brush assembly 113 is inserted in vent 115. Since both flexible tubular conduit 129 and flexible shaft 219 will bend, the brush assembly 113 may be inserted in vents that have various angles that would prevent ordinary cleaning.

After the brush assembly 113 is inserted as far as desired, the flexible shaft motor 141 is engaged, causing flexible shaft 219 of FIG. 3 to rotate within flexible tubular conduit 129. Bearings 217 of FIGS. 3 and 319 of FIG. 4 cooperate to allow flexible shaft 219 and coupled brush shaft 313 to rotate at a high frequency.

Brush 125 will act to dislodge dust 109 from the vent 115 walls. The at least one vacuum motor 137 is engaged to pull a vacuum through vacuum hose 133, sanitary-tee 131, swivel cuff 147 and flexible tubular conduit 129. Since brush 125 substantially occludes vent 115, a good vacuum can be drawn by the at least one vacuum motor 137.

An air stream containing the dislodged dust 109 is pulled thorough intake ports 325 of FIG. 4 into the intake opening 157 of flexible tubular conduit 129. From there, the air stream containing the dust 109 is pulled toward the sanitary-tee 131, where it is diverted into second leg 209 and vacuum hose 133. Next, the air stream is pulled through filter 135 of FIG. 1, and directed to vacuum bag 139 via bag feed conduit 155. The dust 109 is removed from the air stream at filter 135 and vacuum bag 139, and the clean air stream is allowed to vent to the environment. In addition, a vacuum bag pre-filter and appropriate HEPA grade filters can be inserted at appropriate locations along the air streams.

As a method, the vent cleaning system can be described as a combination of the steps of first providing a brush coupled to a flexible rotatable shaft that is disposed within a flexible vacuum conduit. Second, inserting the brush into a selected vent to substantially occluding said vent. Third, rotating said flexible rotatable shaft to cause said brush to rotate in the vent and dislodge the dust. Fourth, applying a vacuum source to the vacuum conduit to draw an air stream containing said dust from the vent and into the conduit. Fifth, removing the brush from the vent while rotating the brush and for vacuuming the dust. The means for rotating the brush and for vacuuming the dust should be independently controllable so that the operator can either dust or vacuum, or both dust and vacuum simultaneously.

This invention has several distinct advantages over the previous system as described in U.S. Pat. No. 4,792,363. As indicated above, the presence of the swivel cuff in the apparatus of the present invention serves not just as a point at which the flexible tubular conduit can be detached from the systems, but due to the nature of a spinning flexible cable within the conduit, it provides several advantages which were not available in the previous systems. For instance, a simple advantage is that when a vacuum job is completed, it is much easier to wrap the conduit around the vacuum unit and avoid the twisting of the cable-containing conduit. Also, and of greater importance, is the fact that the cable life is extended since twisting and toque forces are greatly reduced, if not eliminated entirely. A further advantage is that the presence of the swivel cuff prevents an operator from twisting the conduit at some distance from the apparatus to disconnect it. Therefore, the combination of these and several other advantages are obtained by the inclusion of the swivel cuff in the apparatus of this invention.

Although the invention has been illustrated by the preceding disclosure, it is not to be construed as being limited to the materials employed here, but rather, pertains to the generic area as hereinabove disclosed. Various modifications and embodiments thereof can be made without departing from the spirit and scope hereof.

1-9. (canceled)

10. A method of removing dust from a vent of the type forming an angle with a vent opening and having a vent diameter, the method comprising:
providing an external brush coupled to a flexible shaft, the flexible shaft being, in turn, disposed within a flexible vacuum conduit having a diameter substantially less than said vent diameter for allowing said flexible conduit to be passed through said angle in said vent;
inserting said external brush into said vent opening, thereby substantially occluding said vent;
passing said flexible conduit inward along said vent through said angle;
rotating said flexible shaft to cause said brush to rotate in said vent and dislodge said dust;
applying a vacuum source to said flexible vacuum conduit to draw an air stream containing said dust from said vent into said conduit;
providing a swivel cuff between said vacuum source and an exhaust end of said flexible vacuum conduit so as to minimize torque loads of said flexible shaft; and
removing said brush from said vent.

11. A method according to claim 10, wherein the steps of rotating said flexible shaft, applying said vacuum source, and removing said brush are performed simultaneously.

12. A method according to claim 10 further comprising:
filtering said air stream produced by applying said vacuum source to said vacuum conduit to remove dust.

13. (canceled)
